(19) United States
(12) Patent Application Publication
(10) Pub. No.: US 2016/0342797 A1
(43) Pub. Date: Nov. 24, 2016

(54) SYSTEM AND METHOD OF CONCEALING A USER'S MEASUREMENTS

(71) Applicant: Darren Quintana, Oyster Bay, NY (US)

(72) Inventor: Darren Quintana, Oyster Bay, NY (US)

(21) Appl. No.: 14/952,225

(22) Filed: Nov. 25, 2015

Related U.S. Application Data
(60) Provisional application No. 62/165,580, filed on May 22, 2015.

(51) Int. Cl. G06F 21/60; G06K 7/08

(52) U.S. Cl. CPC G06F 21/602; G06K 7/087

(57) ABSTRACT

A system and method of concealing a user's size information is provided. The user is first measured for a size of at least one body part. The measured size is then entered into a database via software running on a computer. The computer or processor then encrypts the measured size, and thereby transforms the measured size to an encrypted data. The encrypted data is then coupled to a medium. The medium includes a computer readable code that provides access to the encrypted data.

### CROSS-REFERENCE TO RELATED APPLICATION

This application claims the benefit of priority of U.S. provisional application No. 62/165,580, filed May 22, 2015, the contents of which are herein incorporated by reference.

### BACKGROUND OF THE INVENTION

The present invention relates to user sizes and, more particularly, to a system and method of concealing a user's measurements.

A great gift during the holiday season and birthdays includes clothes and shoes. To purchase clothes and shoes for a friend or a loved one, the gift giver must have knowledge of the friend or loved one's measurements. Certain people are self conscious about their measurements, and therefore are hesitant or simply do not provide their measurements to the potential gift giver. The gift giver is thereby prevented from buying shoes or clothes as a gift.

As can be seen, there is a need for a system and method of concealing a user's measurements.

### SUMMARY OF THE INVENTION

In one aspect of the present invention, a method of concealing a user's size information comprises the steps of: measuring a size of at least one body part of a user; entering the measured size of the user to a database via software run on a computer; encrypting the measured size of the user and thereby transforming the measured size to an encrypted data via the software run on the computer; and coupling the encrypted data to a medium, wherein the medium comprises a computer readable code providing access to the encrypted data.

In another aspect of the present invention, a system of concealing a user's size information comprises: at least one processor operable to receive a measured size of at least one body part of a user and encrypt the measured size, thereby transforming the measured size to an encrypted data, a database operable to receive the encrypted data from the at least one processor and store the encrypted data; a medium comprising a computer readable code providing access to the encrypted data; and a terminal operable to read the computer readable code and decrypt the encrypted data, thereby accessing the measured size of the at least one body part of the user.

These and other features, aspects and advantages of the present invention will become better understood with reference to the following drawings, description and claims.

### BRIEF DESCRIPTION OF THE DRAWINGS

FIG. 1 is a schematic view of the present invention demonstrating the user's exemplary size definitions being placed on a coded card; and

FIG. 2 is a schematic overview of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

Broadly, the present invention includes software that stores consumer's sizes on to a coded card and then applies the sizes to orders on retail websites and retail stores. The present invention allows for clients sizes to be placed on a coded card which is then given to loved ones who cannot see the actual sizes of the client. The card is then used online or at retail stores to allow the proper sizes to be purchased. In alternative embodiments, the coded card may also include ring sizes, favorite foods, colors and the like.

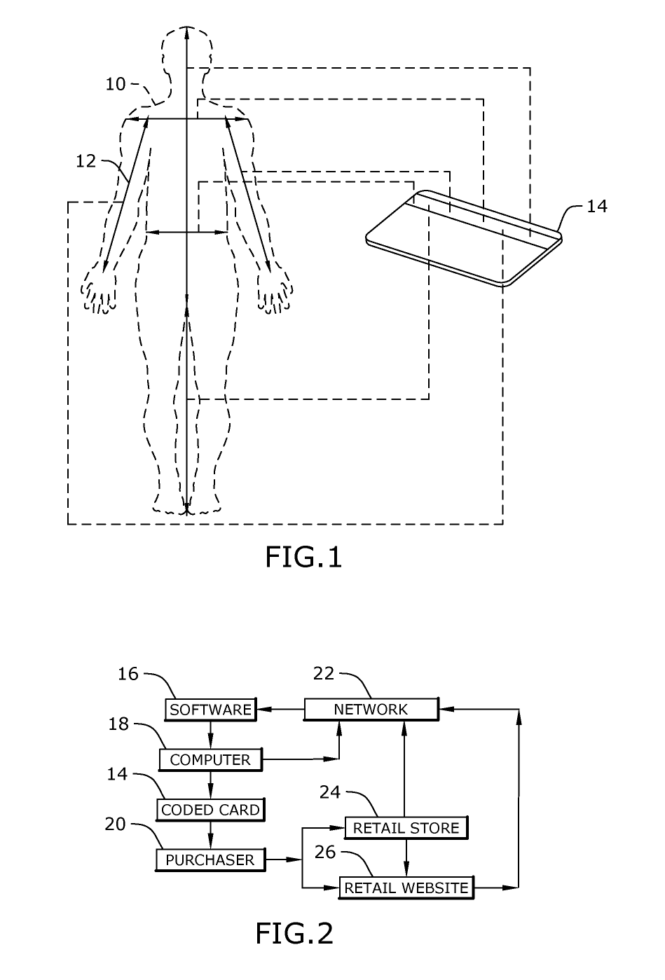

Referring to FIGS. 1 and 2, the present invention includes a system and method of concealing a user's size information. The user 10 is first measured for a size 12 of at least one body part. The measured size 12 is then entered into a database via software 16 running on a computer 18 having a processor and memory. The computer 18 then encrypts the measured size, and thereby transforms the measured size to an encrypted data. The encrypted data is then coupled to a medium 14 by way of a computer readable code. The medium 14 includes the computer readable code that provides access to the encrypted data.

In certain embodiments, the medium 14 includes a physical card. However, the medium 14 is not limited to a physical card and can include an electronic card, an email, a text message and the like. The physical card may include a micro chip, a magnetic strip, or another data storage unit. Once the user has entered their measurements, the user may select who the medium is to be sent to. The medium 14 may then be printed and mailed, or electronically sent to potential buyers 20 that the user's believes will be purchasing the user 10 clothing or shoes.

Once the potential buyer 20 has received the card or electronic message with the computer readable code, the potential buyer 20 may use the medium 14 for purchasing clothes and shoes for the user 10. For example, the potential buyer 20 may physically travel to a retail store 24. The retail store 24 may include a terminal with a processor that is able to decrypt the encrypted data. The potential buyer 20 may provide the medium 14 to an employee of the retail store 24. The employee may then determine the correct sizes of the user using the terminal. The potential buyer 20 may indicate which clothes or shoes they would like to purchase for the user 10. The employee is able to provide the correct sized clothing and shoes to the potential buyer 20.

Alternatively, the potential buyer 20 may use a retail website 26 over a network 22 using the internet. In such embodiments, the potential buyer 20 may enter in the computer readable code to the retail website 26. The retail website 26 thereby accesses the encrypted data and decrypts the data to obtain the measurement information. The potential buyer 20 may then selects the article of clothing or shoes to be purchased for the user 10. The retail website 26 matches the correct sizes to the shoes or articles or clothing and then ships the correct sized shoes and clothing to the user 10. The potential buyer 20 is thereby unable to determine the measurements of the user 10.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of concealing a user's size information comprising the steps of:
measuring a size of at least one body part of a user;
entering the measured size of the user to a database via software run on a computer;
encrypting the measured size of the user and thereby transforming the measured size to an encrypted data via the software run on the computer; and
coupling the encrypted data to a medium, wherein the medium comprises a computer readable code providing access to the encrypted data.

2. The method of claim 1, wherein the medium is a physical card

3. The method of claim 2, wherein the computer readable code is contained on at least one of a micro chip and a magnetic strip.

4. The method of claim 1, further comprising the step of:
decrypting the encrypted data and thereby accessing the measure size by a terminal at a retail location.

5. The method of claim 1, wherein the at least one body part comprises a plurality of body parts comprising a waist, arms, legs, shoulders, a head, and feet.

6. A system of concealing a user's size information comprising:
at least one processor operable to receive a measured size of at least one body part of a user and encrypt the measured size, thereby transforming the measured size to an encrypted data,
a database operable to receive the encrypted data from the at least one processor and store the encrypted data;
a medium comprising a computer readable code providing access to the encrypted data; and
a terminal operable to read the computer readable code and decrypt the encrypted data, thereby accessing the measured size of the at least one body part of the user.

7. The system of claim 6, wherein the medium is a physical card

8. The system of claim 7, wherein the computer readable code is contained on at least one of a micro chip and a magnetic strip.

9. The system of claim 6, wherein the at least one body part comprises a plurality of body parts comprising a waist, arms, legs, shoulders, a head, and feet.

10. The system of claim 6, wherein the terminal is located at a retail location.
